(19) United States
(12) Patent Application Publication
(10) Pub. No.: US 2024/0286203 A1
(43) Pub. Date: Aug. 29, 2024

(54) An electrospindle

(71) Applicant: Saccardo GCF S.r.l., Schio (IT)

(72) Inventors: Marco Povolo, Schio (IT); Piero Mozzato, Schio (IT); Michele Bressan, Schio (IT); Francesca Saccardo, Schio (IT)

(21) Appl. No.: 18/575,258

(22) PCT Filed: Jul. 14, 2022
(86) PCT No.: PCT/IB2022/056486

§ 371 Date: Dec. 28, 2023

(30) Foreign Application Priority Data
Jul. 29, 2021 (IT) 102021000020354

(51) Int. Cl. B23B 31/19

(52) U.S. Cl. CPC B23B 31/19

(57) ABSTRACT

An electrospindle includes a motor for the movement of a tool, a pulling shaft configured to be coupled to the tool and coupled to the motor for the transmission of motion from the motor to the tool, a rotating element connected to the pulling shaft, and a joint stably coupled to the motor and having a through hole arranged to be hit on a first side by a first end of the rotating element. The joint is provided with a fitting for connection to a water supply pipe in the electrospindle that is arranged at a second side of the through hole opposite to the first side. A water sensor is interposed between the fitting and the first side of the through hole so as to detect the passage of water from the through hole in the direction of the motor.

### FIELD OF APPLICATION

The present invention is applicable to the sector of industrial machining and, in particular, relates to a machine tool.

In more detail, the present invention relates to an electrospindle for industrial machining.

### BACKGROUND ART

It is known that the machining of materials in the industrial field is now almost exclusively carried out by means of power tools. In fact, operations such as cutting, bending, milling, drilling or other typically occur by means of special machines provided with the appropriate tools for performing the aforesaid operations.

In many cases, the aforementioned power tools comprise electrospindles, i.e., motorized devices having a drive shaft provided with an end configured to retain radial and/or axial machining tools.

The electrospindles include a type where there is a pulling shaft arranged sliding inside the drive shaft. Therein, the tool is fixed to the pulling shaft by means of a gripper. More in detail, the pulling shaft is movable inside the electrospindle according to its longitudinal extension axis so as to be able to be arranged according to a first retracted working configuration, in which the tool is retained and can therefore be moved, and a second resting configuration in which the pulling shaft is at least partially extracted, allowing the gripper to open, releasing the tool for its replacement or maintenance.

The known electrospindles often also comprise a joint stably coupled to the motor or to the pulling shaft and provided with a fitting for connection to a water supply pipe. The latter, in fact, is necessary to ensure the operation of the electrospindle.

However, the electrospindles described above have some known drawbacks.

In particular, it can occur that the water used for carrying out certain machinings or for cooling the motor runs along the body of the pulling shaft until it reaches the motor itself, thus causing the failure thereof. This occurs especially, but not exclusively, when the electrospindle is used in a vertical position.

In such cases the motor must be replaced before the electrospindle can be used again, with a consequent loss of time and money.

Not only that, the contact of the motor with the water could pose a risk to the technician using the electrospindle.

### PRESENTATION OF THE INVENTION

The object of the present invention is to at least partially overcome the drawbacks highlighted above by providing an electrospindle which allows to prevent the risk of water exiting from the joint and flowing along the pulling shaft until reaching the motor.

In particular, an object of the present invention is to provide an electrospindle which is provided with a sensor that indicates the leakage of water from the joint in the direction of the motor.

It follows that another object of the present invention is to provide an electrospindle which allows an adequate safety level for the technician using it.

A further object of the present invention is to provide an electrospindle which allows to limit the reasons for motor failure.

It follows that, an object of the present invention is to provide an electrospindle which allows to significantly reduce maintenance costs.

Moreover, another object of the present invention is to provide an electrospindle which allows to limit machine downtime for maintenance.

Said objects, as well as others which will become clearer below, are achieved by an electrospindle in accordance with the following claims, which are to be considered an integral part of the present patent.

In particular, the electrospindle of the invention comprises at least one motor for moving a tool to which is operatively coupled at least one pulling shaft which is operatively couplable to the tool for transmitting motion from the motor to the tool.

The electrospindle further comprises at least one rotating element operatively connected to the pulling shaft.

Furthermore, the electrospindle of the invention comprises at least one joint stably coupled to the motor and having at least one through hole capable of being hit in a first side by at least a first end of the rotating element. Moreover, the joint is provided with a fitting for connection to a water supply pipe arranged at a second side of the through hole opposite the first side.

Advantageously, the presence of the fitting for connection to a water supply pipe allows the insertion of water into the joint for cooling the electrospindle motor, or for carrying out certain machining.

According to an aspect of the invention, the joint comprises a water sensor interposed between the fitting and the first side of the through hole.

Advantageously, the presence of the water sensor allows to detect the passage of water from the through hole in the direction of the motor.

Still advantageously, the above allows to stop the motor before the water reaches it, damaging it.

Still advantageously, the presence of the water sensor allows to ensure an adequate safety level for the technician employed in the use of the electrospindle of the invention.

Still advantageously, in the electrospindle of the invention the reasons for failure and, consequently, the maintenance costs with respect to the equivalent electrospindles of the prior art are limited.

It follows that, still advantageously, the machine downtime of the electrospindle of the invention is also limited with respect to what occurs in the known electrospindles.

### BRIEF DESCRIPTION OF THE DRAWINGS

Further features and advantages of the invention will become more evident in light of the detailed description of a preferred but not exclusive embodiment of an electrospindle according to the invention, illustrated by way of non-limiting example with the aid of the accompanying drawings, in which:

FIG. 1 depicts an electrospindle according to the invention in a partially sectioned side view;

FIGS. 2 to 4 depict details of the electrospindle of FIG. 1

### DETAILED DISCLOSURE OF SOME PREFERRED EXEMPLARY EMBODIMENTS

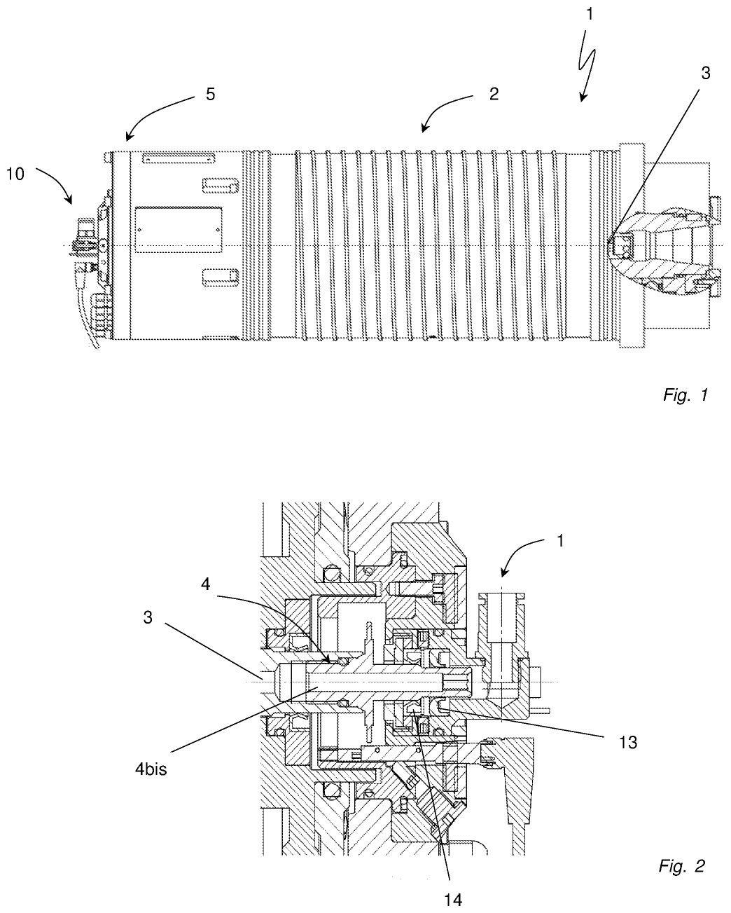

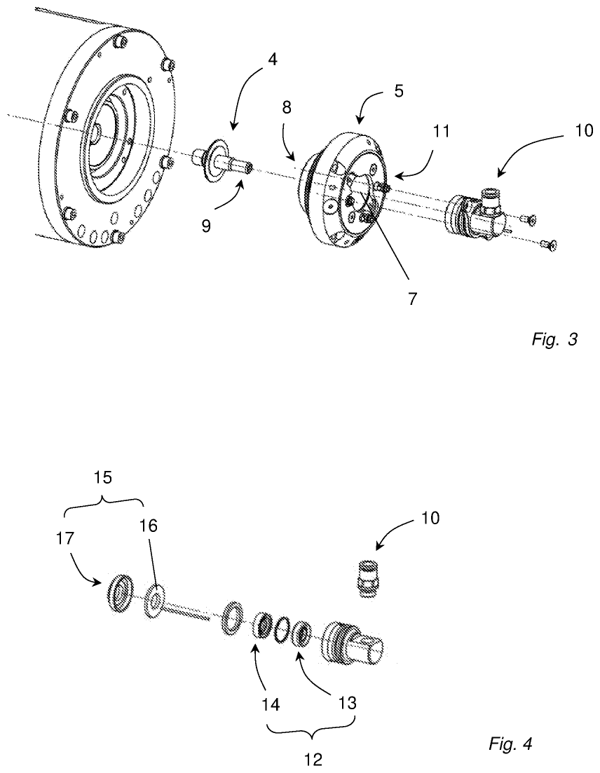

With reference to the above-mentioned figures, and in particular to FIGS. 1 and 2, an electrospindle 1 is described.

It comprises a motor 2 for moving a tool to which is operatively coupled a pulling shaft 3 which is operatively couplable to the tool so as to transmit motion from the motor 2 thereto.

The electrospindle 1 further comprises at least one rotating element 4 operatively connected to the pulling shaft 3. In the embodiment described, the rotating element 4 comprises a signalling cam 4bis. In fact, as is known, the pulling shaft 3 assumes an extracted position to release the tool and a retracted position to hold the tool in position.

Advantageously, the presence of the signalling cam 4bis allows to detect the position of the pulling shaft 3 so as to ensure the safe use of the electrospindle 1.

However, such an aspect must not be considered limiting for different embodiments of the invention according to which the rotating element comprises a rotating shaft or, even more simply, consists of the free end of the pulling shaft made in a single body with the shaft itself.

The electrospindle 1 of the invention also comprises a joint 5 stably coupled to the motor 2 and having, as shown in FIG. 3, a through hole 7 capable of being hit in a first side 8 by a first end 9 of the signalling cam 4bis. Moreover, the joint 5 is provided with a fitting 10 for connection to a water supply pipe arranged at a second side 11 of the through hole 7 opposite the first side 8.

The presence of the fitting 10 for connection to a water supply pipe allows the insertion of water into the joint 5 for cooling the motor 2 of the electrospindle 1, or for carrying out certain machining.

According to an aspect of the invention, the joint 5 comprises a sealing group 12 interposed between the fitting 10 and the through hole 7 and arranged circumferentially to the first end 9 of the signalling cam 4bis.

As is known, the presence of the sealing group 12 is due to the need to avoid the risk of water passage from the through hole 7 towards the motor 2. In fact, otherwise the motor 2 risks failure due to the contact with water.

In particular, according to another aspect of the invention, the sealing group 12 comprises, as can also be seen in the detail in FIG. 4, a first annular gasket 13 arranged in contact with the first end 9 of the signalling cam 4bis.

As can be seen in the figures, the first annular gasket 13 appears as a circular body arranged around the signalling cam 4bis. However, such a form should not be considered limiting for different embodiments of the invention according to which the first annular gasket has any different geometric shape as long as it is sealed on the cam.

According to a further aspect of the invention, the sealing group 12 further comprises a second annular seal 14 also arranged in contact with the first end 9 of the signaling cam 4bis and spaced from the first annular gasket 13.

Advantageously, the existence of a space between the first annular gasket 13 and the second annular gasket 14 allows to make a tank where lubricants for the lubrication of the first annular gasket 13 if not also of the second annular gasket 14 can be maintained. However, such an aspect of the invention should not be considered limiting for different embodiments of the invention. In fact, instead of lubricants, only air or other could be present in the tank.

Advantageously, the foregoing allows to avoid the early drying of the sealing group 12, ensuring the seal to the passage of water for a longer time.

However, the foregoing should not be considered limiting for different embodiments of the invention according to which the sealing group comprises only one or more than two annular gaskets.

According to another aspect of the invention, the joint 5 comprises a water sensor (15) interposed between the fitting 10 and the first side 8 of the through hole 7, and in particular between the sealing group 12 and the first side 8 of the through hole 7.

Advantageously, the presence of the water sensor 15 allows to detect the passage of water from the through hole 7 in the direction of the motor 2.

Still advantageously, the above allows to signal the passage of water before it reaches the motor 2, allowing it to stop in an emergency.

Again advantageously, this allows to prevent the failure of the motor 2 due to the presence of water therein.

It follows, advantageously, that the presence of the water sensor 15 allows to save costs for the replacement of the motor 2, which, in the electrospindles of the prior art, sometimes occur precisely because of water leakage.

Furthermore, still advantageously, the foregoing allows to significantly reduce the occasions in which so-called machine downtime is necessary.

Still advantageously, the presence of the water sensor 15 allows to ensure a higher safety level for the technician employed in the use of the electrospindle 1 with respect to the electrospindles of the prior art.

More in detail, according to the embodiment shown here, the water sensor 15 comprises an electrically conductive annular body 16 arranged circumferential to the first end 9 of the signalling cam 4bis. However, such an aspect must not be considered limiting for different embodiments of the invention according to which the water sensor has any shape and is arranged at different portions of the signalling cam.

Appropriately, the annular body 16 is separate with respect to the signalling cam 4bis so as to ensure the mutual electrical insulation thereof. Accordingly, advantageously, maintaining a distance between the annular body 16 and the signaling cam 4bis allows to detect the possible passage of water along the signaling cam 4bis in the direction of the motor 2. In fact, it is sufficient to detect the passage of electric current between the signalling cam 4bis and the annular body 16 to deduce that there is water therebetween making the electrical bridge.

According to a further aspect of the invention, the sensor 15 comprises a container 17 for the annular body 16.

Advantageously, the presence of the container 17 allows to retain the annular body 16 in the correct position.

In such a sense, suitably the container 17 is also shaped to make a stable coupling with the joint 5 in the through hole 7.

According to a further aspect of the invention, the container 17 comprises electrically insulating material arranged so as to ensure the electrical insulation between the annular body 16 and the joint 5.

As said, the sensor 15 allows the passage of water to be electrically detected. Such a detection can be used in various manners, for example by means of light signalling.

However, according to another aspect of the invention, the electrospindle 1 comprises a relay, not depicted here, having a movable contact and a drive circuit.

In particular, the movable contact is interposed between the electric power supply of the electrospindle 1 and the electrospindle 1 itself. Conversely, the drive circuit is electrically interposed between the electric power supply and the water sensor 15.

Operatively, when it does not draw water, the drive circuit is an open circuit because there is no electrical contact between the annular body 16 and the signaling cam 4bis, which, as is known, is electrically connected to ground.

Conversely, when water is drawn, this makes a short circuit between the annular body 16 and the signalling cam 4bis, closing the drive circuit between the electric power supply and the ground. As a result, the state of the movable contact changes. Thereby, the power circuit of the electrospindle 1 is opened which is then turned off for safety reasons.

Advantageously, the presence of a relay allows to automatically turn off the electrospindle 1 in the event of detection of water passage by the sensor 15. Still advantageously, the automatic turning off of the electrospindle 1 allows to avoid the risk of failure of the motor 2 in the event of contact with water.

Moreover, still advantageously, the presence of the relay which allows the automatic turning off of the electrospindle 1 once again increases the safety level for the technician employed in the use thereof.

Although advantageous, as mentioned, the presence of a relay should not be considered a limiting feature of the invention. In fact, in can be replaced by other equally suitable means to avoid continuing to power the motor with the risk of damage.

In light of the foregoing, it is understood that the electrospindle of the invention achieves all the intended purposes.

In particular, the electrospindle of the invention allows to prevent the risk that water exits from the joint and runs along the pulling shaft until it reaches the motor.

In particular, it is provided with a sensor which detects the water leakage from the joint in the direction of the motor.

It follows that the electrospindle of the invention allows an adequate safety level for the technician employed in its use.

Furthermore, it allows to avoid motor failure.

On closer inspection, the electrospindle of the invention allows to significantly reduce the maintenance costs of the electrospindle.

Moreover, the electrospindle of the invention allows to limit the reasons for machine downtime.

The invention might be subject to many changes and variants, which are all included in the appended claims. Moreover, all the details may furthermore be replaced by other technically equivalent elements, and the materials may be different depending on the needs, without departing from the protection scope of the invention defined by the appended claims.

The invention claimed is:

1. An electrospindle comprising:
a motor (2) for moving a tool;
a pulling shaft (3) configured to be operatively coupled to the tool and operatively coupled to said motor (2) for a transmission of motion from said motor (2) to the tool;
a rotating element (4) operatively connected to said pulling shaft (3); and
a joint (5) stably coupled to said motor (2) and having at least one through hole (7) disposed to be hit on a first side (8) by a first end (9) of said rotating element (4), said joint (5) being provided with a fitting (10) for connection to a water supply pipe in said electrospindle (1), said fitting (10) being arranged at a second side (11) of said through hole (7) opposite to said first side (8),
wherein said joint (5) comprises a water sensor (15) interposed between said fitting (10) and said first side (8) of said through hole (7) so as to detect a passage of water from said through hole (7) toward said motor (2).

2. The electrospindle according to claim 1, wherein said joint (5) comprises a sealing group (12) interposed between said fitting (10) and said water sensor (15) and arranged circumferentially to said first end (9) of said rotating element (4).

3. The electrospindle according to claim 2, wherein said sealing group (12) comprises a first annular gasket (13) arranged to be in contact with said first end (9) of said rotating element (4).

4. The electrospindle according to claim 3, wherein said sealing group (12) comprises a second annular gasket (14) arranged to be in contact with said first end (9) of said rotating element (4) and spaced from said first annular gasket (13) to identify a space for retaining lubricant of said first annular gasket (13).

5. The electrospindle according to claim 1, wherein said water sensor (15) comprises an electrically conductive annular body (16) arranged circumferentially to said first end (9) of said rotating element (4) and separate therefrom so as to avoid an electrical contact between said electrically conductive annular body (16) and said rotating element (4).

6. The electrospindle according to claim 5, wherein said water sensor (15) comprises a container (17) for said electrically conductive annular body (16).

7. The electrospindle according to claim 6, wherein said container (17) is shaped to make a stable coupling with said joint (5) in said through hole (7).

8. The electrospindle according to claim 7, wherein said container (17) comprises an electrically insulating material arranged so as to ensure an electrical insulation between said electrically conductive annular body (16) and said joint (5).

9. The electrospindle according to claim 1, further comprising a relay having a movable contact and a drive circuit, said movable contact being electrically interposed between an electric power supply of said electrospindle (1) and said electrospindle (1), said drive circuit being electrically interposed between the electric power supply and said water sensor (15).
